(19) United States
(12) Patent Application Publication
(10) Pub. No.: US 2006/0180713 A1
(43) Pub. Date: Aug. 17, 2006

(54) Clevis hanger pipe support and method

(76) Inventors: Raymond M. Olle, Brecksville, OH (US); Raymond S. Laughlin, Middlefield, OH (US); Richard W. Lees, Stow, OH (US)

Correspondence Address: Jonathan A. Platt;Renner, Otto, Boisselle & Sklar, LLP, Nineteenth Floor, 1621 Euclid Avenue, Cleveland, OH, 44115, US

(21) Appl. No.: 11/361,348

(22) Filed: Feb. 24, 2006

Related U.S. Application Data
(63) Continuation of application No. PCT/US06/00384, filed on Jan. 5, 2006.
(60) Provisional application No. 60/652,195, filed on Feb. 11, 2005.

(51) Int. Cl. E21F 17/02; F16L 3/00

(52) U.S. Cl. 248/58

(57) ABSTRACT

A clevis hanger pipe support includes a bottom pipe-receiving portion and a top portion for coupling to structure such as a threaded rod. The portions are releasably held together by an unthreaded fastener, such as a retaining pin or a retaining bar. The top and bottom portions of the clevis hanger have respective apertures which, when aligned, allow the fastener to be inserted or removed, thereby mechanically coupling or de-coupling the top and bottom portions of the clevis hanger. When the apertures of the top and bottom portion are misaligned from one another, extraction of the fastener from the apertures is prevented. The apertures may be elongated slots. The fastener may be a suitably-shaped pin or bar.

This application is a continuation of PCT/US06/00384, filed Jan. 5, 2006, which claims priority from U.S. Provisional Application 60/652,195, filed Feb. 11, 2005. This application also claims priority from U.S. Provisional Application 60/652,195. Both of the above applications are hereby incorporated by reference in their entireties.

### BACKGROUND OF THE INVENTION

1. Field of the Invention

The invention relates to pipe supports, such as pipe supports used suspend pipe runs from building structure.

2. Description of the Related Art

Clevis pipe hangers are often used in securing runs of pipe to building structure. Such pipe hangers typically consist of top and bottom portions that are mechanically secured together by passing a threaded bolt or stud through circular holes in the sections, and using one or more nuts to retain the stud or bolt in place. Such clevis pipe hangers are generally sold in an assembled configuration. Assembly or disassembly of such pipe hangers requires handling multiple parts, and threaded nuts onto or off of bolts or studs.

Improvements in pipe hangers would be desirable.

### SUMMARY OF THE INVENTION

According to an aspect of the invention, a clevis hanger for supporting a pipe includes: a top portion having a pair of top apertures therein; a bottom portion having a pair of bottom apertures therein; and a non-threaded fastener that is within the top apertures and the bottom apertures, thereby releasably securing the top portion and the bottom portion together. The bottom portion has a curved pipe-receiving section for receiving a pipe thereupon, secured within the top portion and the bottom portion.

According to another aspect of the invention, a clevis pipe hanger includes a top portion, a bottom pipe-receiving portion, and a non-threaded fastener separably coupling the top portion and the bottom potion together. The non-threaded fastener may pass through apertures in legs of the top potion and the bottom portion. The non-threaded fastener may be a retainer pin or a retainer bar. The apertures may be slots that must be aligned to allow a portion of the fastener to pass therethrough.

### BRIEF DESCRIPTION OF THE DRAWINGS

In the annexed drawings, which are not necessarily to scale:

FIG. 1 is an oblique view of a clevis hanger pipe support in accordance with the present invention;

FIG. 2 is an exploded view of the clevis hanger of FIG. 1;

FIG. 3 is an end view of the retaining pin fastener of the clevis pipe hanger of FIG. 1;

FIG. 4 is a side view illustrating alignment of multiple apertures of the pipe hanger of FIG. 1;

FIG. 5 is a side view illustrating misalignment of the same apertures shown in FIG. 4;

FIG. 6 is an oblique view illustrating multiple of the clevis hangers of FIG. 1, used to support a pipe;

FIG. 7 is an oblique view of a first alternate embodiment clevis hanger in accordance with the present invention;

FIG. 8 is an oblique view of a second alternate embodiment clevis pipe hanger in accordance with the present invention;

FIG. 9 is a plan view of the retaining bar fastener of the clevis hanger of FIG. 7;

FIG. 10 is an oblique view of a third alternate embodiment clevis pipe hanger in accordance with the present invention;

FIG. 11 is a side view of alignment of the apertures of the top and bottom portions of the clevis hanger of FIG. 10; and

FIG. 12 is a side view of a retaining fastener of the clevis hanger of FIG. 10.

### DETAILED DESCRIPTION

A clevis hanger pipe support includes a bottom pipe-receiving portion and a top portion for coupling to structure such as a threaded rod. The portions are releasably held together by an unthreaded fastener, such as a retaining pin or a retaining bar. The top and bottom portions of the clevis hanger have respective apertures which, when aligned, allow the fastener to be inserted or removed, thereby mechanically coupling or de-coupling the top and bottom portions of the clevis hanger. When the apertures of the top and bottom portion are misaligned from one another, extraction of the fastener from the apertures is prevented. The misalignment of the apertures may be caused by pulling the bottom portion of the clevis hanger downward relative to the top portion, such as is caused by the weight of a pipe pulling the bottom portion downward. The portions of the fastener that are within the apertures when the clevis hanger is assembled may be narrower than outboard ends of the fastener, in order to prevent accidental or unintended dislodgement or disengagement of the fastener from the slot. The fastener ends may be bent ends or widened ends that have a larger cross-sectional area than the portions of the fastener that are in the apertures when the fastener is installed. The apertures may be elongated slots, or may have other suitable shapes. The fastener may be a suitably-shaped pin or bar. The fastener may also have protrusions or widened central sections to aid in preventing inward deflection of the legs of one or both portions of the clevis hanger. In an alternative embodiment, the non-threaded fastener has a protrusion, which has to be aligned with a similar-shape protrusion or extension of the apertures, in order to engage or disengage the non-threaded fastener. The clevis hangers of the present invention advantageously allow for faster installation and de-installation than is possible with prior art clevis hangers utilizing threaded fasteners. In addition, manufacturing costs may be reduced since the non-threaded fasteners of the present clevis hanger may allow for quicker factory assembly of clevis hangers, or may enable sale of clevis hangers in disassembled configurations.

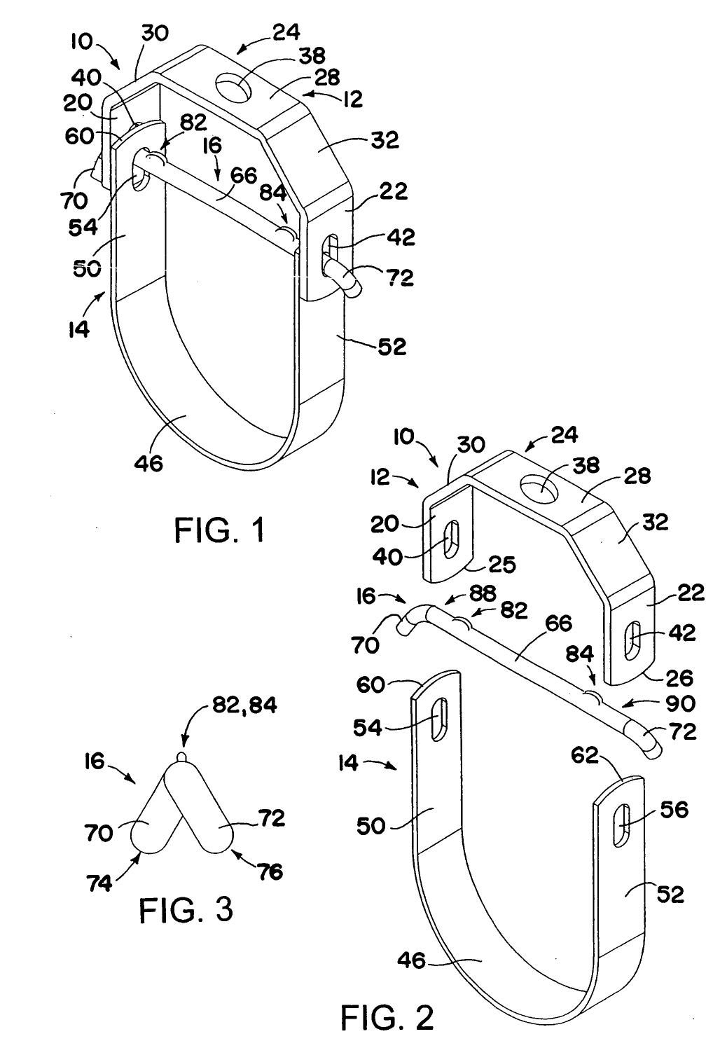

Referring initially to FIGS. 1 and 2, details of a clevis hanger pipe support 10 are shown. The clevis hanger 10 includes a top portion 12, a bottom pipe-receiving portion 14, and a fastener 16 that separably joins the top portion 12 and the bottom portion 14 together.

The top portion 12 includes a pair of downward extending legs 20 and 22, linked together by a linking support 24. The top portion legs 20 and 22 have respective curved ends 25 and 26. The linking support 24 includes a horizontal central section 28, and a pair of diagonal sections 30 and 32 extending from respective sides of the horizontal central section 28, and linking the horizontal central section 28 to the downward-extending legs 20 and 22. The diagonal sections 30 and 32 may be at roughly 45-degree angles to the horizontal central section 28, and to the legs 30 and 32. The horizontal central section 28 has a rod-receiving hole 38 for receiving a rod, such as a suitable threaded rod, for securing the clevis hanger 10 to structure, such as the structure of a building. The top-potion legs 20 and 22 have respective top-portion apertures 40 and 42 therein. In the illustrated embodiment, the apertures 40 and 42 are elongated slots, having a height (direction along the lengths of the legs 20 and 22) greater than their width (direction perpendicular to the height).

The top portion 12 may be made of a single piece of material, such as a suitable piece of spring steel. The angles between the various sections of the top portion 12 may be made in suitable bending operations. The rod-receiving hole 38, and the apertures 40 and 42, may be made by suitable processes, such as machining. It will be appreciated that the top portion 12 may be made from a variety of other suitable materials, by a variety of suitable processes. In addition, the linking support 24 that links the downward-extending legs 20 and 22 may have any of a variety of suitable other configurations.

The bottom portion 14 includes a central curved pipe-receiving section 46, and upward-protruding bottom portion legs 50 and 52 extending upward from the curved section 46. The legs 50 and 52 have respective bottom portion apertures 54 and 56 therein. In the illustrated embodiment, the bottom portion apertures 54 and 56 are elongated slots that are configured so as to selectively either be in alignment with or out of alignment (misaligned) with the top apertures 40 and 42. When the bottom apertures 54 and 56 are aligned with the top apertures 40 and 42, the fastener 16 may be inserted or removed from the aligned apertures. When the bottom apertures 54 and 56 are out of alignment with the top apertures 40 and 42, the fastener 16, if already inserted, is secure and unable to be removed. Thus alignment of the top apertures 40 and 42, and the bottom apertures 54 and 56, is required to either mechanically couple or de-couple the top portion 12 to the bottom portion 14.

The bottom portion legs 50 and 52 have respective curved ends 60 and 62.

When the clevis hanger 10 is assembled (as shown in FIG. 1), the top portion legs 20 and 22 overlap and are located outside of the bottom portion legs 50 and 52. However, it will be appreciated that this configuration may be reversed, with the hanger 10 configured so that the legs of the bottom portion are located outside of and overlap the legs of the top portion.

The bottom portion 14 may be made of the same material as top portion 12. The top portion 12 and the bottom portion 14 may be fabricated using suitable well-known processes, such as bending and machining. The top portion 12 and the bottom portion 14 may be manufactured from hot or cold rolled milled steel, although it will be appreciated that other suitable materials, such as suitable composite materials like fiber reinforced plastic, may alternatively be used. The top portion 12 may be made of a thicker and/or stronger material than the bottom portion 14. For example, the top portion 12 may have a thickness approximately twice that of the bottom portion 14.

The fastener 16 in the illustrated embodiment is a retaining pin having a generally circular cross section. The retaining pin 16 has a cylindrical central section 66 and a pair of bent ends 70 and 72. At the bent ends 70 and 72, the material of the retaining pin 16 is bent such that the bent ends 70 and 72 can pass through the top apertures 40 and 42, and the bottom apertures 54 and 56, only when the apertures are aligned. The bends may be made at approximately right angles to the general longitudinal direction of the central section 66. The bent ends 70 and 72 may have rounded tips 74 and 76 to facilitate installation of the retaining pin 16.

It is advantageous that the bent ends 70 and 72 not be co-planar. That is, it is advantageous that the bend of the bent end 70 be in a different direction than that of the bent end 72. For example, as illustrated in FIG. 3, there may be a difference of about 45 degrees in the planarity of the angles for the two bends 70 and 72. By varying the angle between the bends of the two bent ends 70 and 72, the bent ends 70 and 72 naturally settle relative to the apertures 40, 42, 54, and 56, such that the bent ends 70 and 72 are not vertically oriented. That is, the fastener 16 settles such that the bent ends 70 and 72 are not oriented in the vertical direction, which as shown is the direction of the elongated height of the apertures. It will be appreciated that the angle between the bends of the bent ends 70 and 72 may be varied over a wide variety of angles, for example, ranging from zero (bent ends being co-planar and in the same direction) to 180 degrees (bent ends being co-planar and in opposite directions).

The fastener 16 has pairs of pinched protrusions 82 and 84 at either end of the cylindrical center section 66. Each of the pairs of pinched protrusions 82 and 84 has a pair of diametrically opposed protrusions. In the figures, only one protrusions of each of the pairs 82 and 84 is visible. The pinched protrusions 82 and 84 assist in preventing movement of the top portion legs 20 and 22, and/or the bottom portion legs 50 and 52, inward along the fastener 16. The pinched protrusions pairs 82 and 84, in conjunction with the bent ends 70 and 72, define narrowed portions 88 and 90. The narrowed portions 88 and 90 are narrowed in the sense that they fit more easily through the apertures 40, 42, 54, and 56, than either the portions of the fastener 16 that are closer to the center (the pairs of pinched protrusions 82 and 84) or the portions of the fasteners 16 that are farther from the center (the bent ends 70 and 72).

The retaining pin 16 may be made out of standard steel rod. Suitable well-known machining operations may be used to create the bent ends 70 and 72, and to create the pinched protrusions 82 and 84.

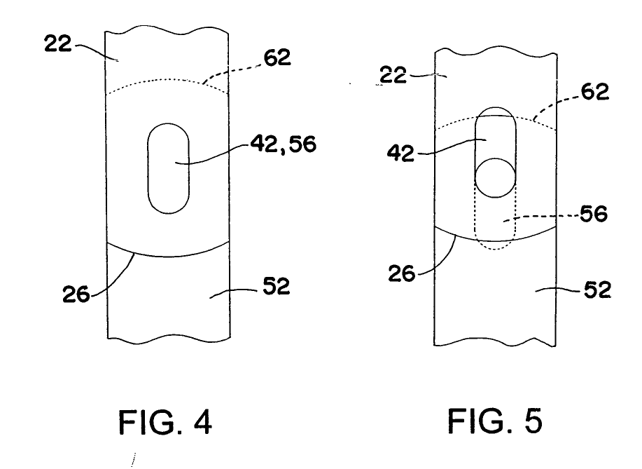

FIGS. 4 and 5 illustrate the alignment and misalignment of the apertures of the top portion 12 and the bottom pipe-receiving portion 14. FIG. 4 shows the top portion aperture 40 aligned with the bottom portion aperture 54. With this alignment of the apertures the retaining pin 16 may be easily inserted through the apertures, with perhaps some twisting needed in order to line up one of the bent ends 70 and 72 (FIGS. 1 and 2), with the aligned apertures 40 and 54.

FIG. 5 shows the apertures 40 and 54 out of alignment with one another. As discussed above, the apertures 40 and 54 may be brought out of alignment due to the pulling down of the bottom portion 14 by the weight of a pipe that is supported by the hanger 10 (FIG. 1). The apertures 40 and 54 may be out of alignment such that the bent ends 70 and 72 (FIGS. 1 and 2), and the pinched protrusions 82 and 84 (FIGS. 1 and 2), no longer fit through the narrowed overlap between the apertures 40 and 54. The apertures 40 and 54 may be misaligned such as to clamp one of the narrowed portions 88 and 90 (FIGS. 1 and 2) of the retaining pin 16 between the top portion leg 20 and the bottom portion leg 50.

It will be appreciated that the alignment referred to above need not be a perfect alignment. The terms “alignment” and “misalignment” should be interpreted relatively, such that “alignment” may be understood as “in more alignment (sufficient to allow insertion or removal of the fastener),” and “misalignment” may be understood as “in less alignment (insufficient to allow insertion or removal of the fastener).”

The apertures are shown in the illustrated embodiment as being elongated slots. It will be appreciated that the apertures may have other suitable shapes for example, being ovals or circular holes of a suitable diameter. The apertures may also have more complicated shapes, for example, having shapes that allow passage of a protrusion on the fastener 16 only when the fastener 16 is in proper alignment with the corresponding portion of the aperture.

The retaining pin 16 has been described as having a generally circular cross section. It will be appreciated that other cross-sectional shapes may be employed. For example, rectangular, hexagonal, or other shapes may be utilized.

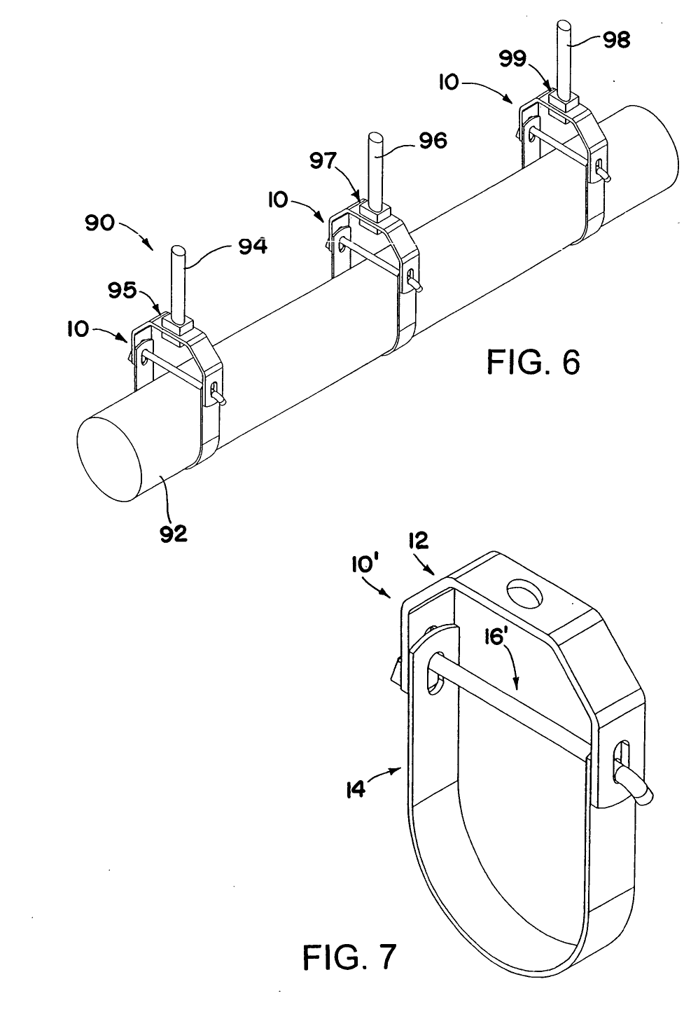

FIG. 6 shows a system 90 for supporting a pipe 92. The system 90 includes multiple of the clevis pipe-support hangers 10. Threaded support rods 94, 96, and 98 extend downward from building structure (not shown), such as a roof support structure. The threaded rods 94, 96, and 98 pass through the rod-receiving holes 38 of respective of the clevis hangers 10. Pairs of nuts 95, 97, and 99 are used to secure the pipe hangers 10 to the respective threaded rods 94, 96, and 98. Thus the system 90 may be used to secure pipes of any of a wide variety of diameters, over any variety of lengths of pipe run. For example the pipe 92 may have a diameter of 10 cm (4 inches).

FIG. 7 shows an alternate embodiment clevis hanger 10′, which has a retaining pin 16′ for which the pinched protrusions 88 and 90 (FIGS. 1 and 2) are omitted. In other aspects the retaining pin 16′ may be identical to the retaining pin 16 described above. The hanger 10′ may utilize the same top portion 12 and bottom portion 14 as the hanger 10 (FIG. 1) described above. By omitting the pinched portions 88 and 90, manufacturing time and fabrication costs of the retaining pin 16′ may be reduced.

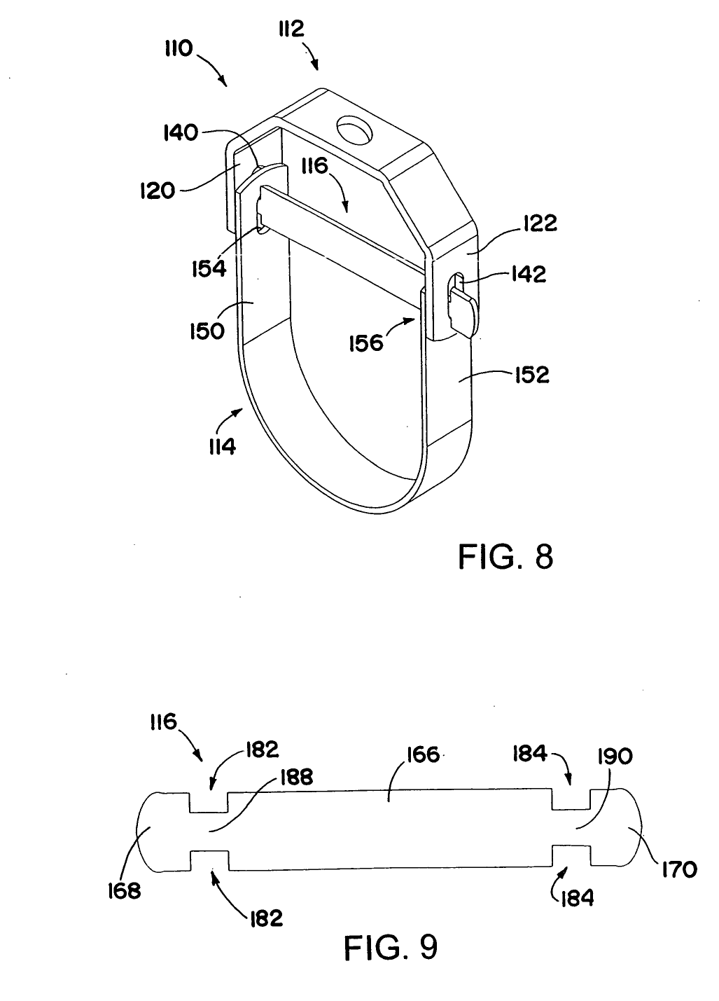

FIGS. 8 and 9 show an alternate embodiment clevis hanger 110 that utilizes a notched bar as a fastener 116 for joining together a top portion 112 and a bottom pipe-receiving portion 114. Many aspects of the top portion 112 and the bottom portion 114 are similar to those of the top portion 12 and the bottom portion 14 described above. In the embodiment illustrated in FIG. 8, top portion legs 120 and 122 are located outside bottom portion legs 150 and 152, farther from the center of the hanger 110. It will be appreciated that alternatively the hanger 110 may be configured so that the top portion legs 120 and 122 are inboard of the bottom portion legs 150 and 152.

Top apertures 140 and 142 and bottom apertures 154 and 156 may be similar in shape and function to the apertures 40, 42, 54, and 56 described above. Thus the apertures of the hanger 110 may also be elongated slots, or may have other suitable shapes.

The retaining bar 116 has pairs of notches 182 and 184 on either side of a center section 166 of the retaining bar 116. The pairs of notches 182 and 184 provide a reduced cross section of the retaining bar 116, relative to both the center section 166 and ends 170 and 172. The pairs of notches define respective narrowed portions 188 and 190 of the retaining bar 116. The narrowed portions 188 and 190 are located such that they are within the apertures 140, 142, 154, and 156, when the fastener or retaining bar 116 is installed so as to mechanically couple the top portion 112 and the bottom portion 114 together. The presence of the notches 182 and 184 allows misalignment of the top apertures 140 and 142 relative to the bottom apertures 154 and 156, with material from the top portion legs 120 and 122 and the bottom portion legs 150 and 152 entering into the notches 182 and 184. This secures the hanger 110 in a mechanically coupled configuration, with the retaining bar 116 unable to be removed from the apertures of the top and bottom portions. If removal of the fastener or retaining bar 116 is desired, the bottom portion 114 may be moved relative to the top portion 112 so as to align the top portion apertures 140 and 142 with the bottom portion apertures 154 and 156.

The central section 166 is wider than the narrowed portions 188 and 190. This prevents inward movement of the top portion legs 120 and 122, and the bottom portion legs 150 and 152. Thus the wider center section 166 may perform a function similar to that of the pinched protrusions 82 and 84 (FIG. 2).

The fasteners 16 and 116 are shown as having ends that are identical, that is, ends that either one of which may be used to insert the fastener through aligned apertures or slots to engage top and bottom portions of a hanger. It will be appreciated that alternatively the fastener may have only one end that is suitably configured for inserting through aligned apertures, if desired.

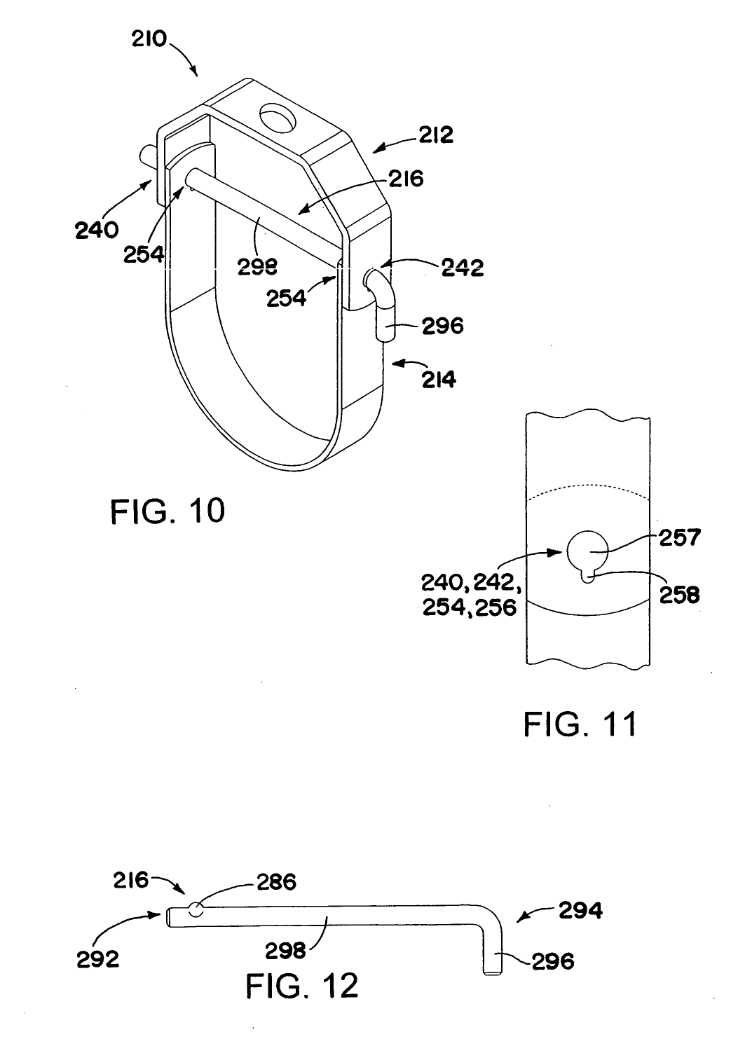

FIGS. 10-12 illustrate another alternate embodiment, a clevis hanger pipe support 210 that utilizes apertures having a different shape from the other embodiments described above. The clevis hanger 210 has a top portion 212 with top apertures 240 and 242, and a bottom portion 214 with bottom apertures 254 and 256. The apertures 240, 242, 254, and 256 all have keyhole-shapes, each having a generally circular portion 257, and each also having an additional extension or protruding portion 258 (FIG. 11) that breaks the axisymmetry of the apertures 240, 242, 254, and 256. The protruding portions 258 may be in a generally downward direction.

With reference now to FIG. 12, a fastener or retaining pin 216 has a protrusion 286 at one end 292. The protrusion 286 is configured such that the portion of the retaining pin 216 with the protrusion 286 passes through the apertures 240, 242, 254, and 256 only when the protrusion 286 is aligned with the protruding portion 258 of the apertures 240, 242, 254, and 256. The protrusion 286 may be a pinched protrusion, which may be have similar dimensions to the protrusions 82 and 84 (FIG. 2), and/or may be made in a similar manner to the protrusions 82 and 84.

At an opposite end 294, the retaining pin 216 has a bent end 296 that prevents passage of the end 294 into or through the apertures 240, 242, 254, and 256. The bent end 296 may be similar in configuration to the bent ends 70 and 72 (FIG. 2) of the retaining pin 16. Thus the bent end 296 may be an approximately right-angle bend of the material of the retaining pin 216.

The bent end 296 may extend from a central portion 298 of the retaining pin 216, in a direction substantially opposite from that of the protrusion 286. Thus, as seen in FIG. 12, the retaining pin 216 may naturally (under the influence of gravity) assume a position with the bent end 296 pointed downward, and the protrusion 286 pointed upward. Since the protruding portions 258 extend downward from the circular portions of the apertures 240, 242, 254, and 256, the natural position assumed by the retaining pin 216 tends to prevent accidental dislodgement or disengagement of the retaining pin 216 from the portions 212 and 214. For insertion or removal, the retaining pin 216 may be turned to align the protrusion 286 with the aperture protruding portions 258.

It will be appreciated that the locking feature described in the previous paragraph may be accomplished in a variety of alternative configurations of the bent end 296, the protrusion 286, and the aperture protruding portions 258. For instance, the bend end 296 and the protrusions 286 may extend from the retaining pin central portion 298 in substantially the same direction, with the aperture protruding portions 258 extending upward. Many other configurations are possible.

It will be appreciated that not all of the apertures 240, 242, 254, and 256 need have the same shape. For example, only some of the apertures may have the non-axisymmetric shape with the protrusion, while other of the apertures may have larger circular shapes that would allow the protrusion 286 to pass therethrough, regardless of the orientation of the fastener 216.

The clevis hangers 10, 10′, 110, and 210 provide many advantages over prior art clevis hangers that utilize threaded fasteners. The non-threaded fasteners 16, 16′ and 116 may be installed more rapidly than threaded fasteners. Also, the non-threaded fasteners 16 and 116 are single pieces, which avoid use of multiple pieces, such as a nut and a bolt, to hold together top and bottom sections of the clevis hanger. Avoiding multi-piece threaded fasteners may reduce difficulties in keeping track of multiple fastener pieces.

Reducing of the fastener installation or de-installation time may significantly reduce time in installing clevis hangers for supporting pipe. Pipe support installations may be a time-consuming and labor-intensive process, the time and effort of which may be reduced by use of non-threaded fasteners such as the fasteners.

In addition, a significant expense during the manufacture of threaded clevis hangers comes from the time needed to couple the parts together using the threaded fastener. The non-threaded fasteners have a reduced coupling time, which may reduce manufacturing personnel costs for the clevis hangers. Further, it may be possible to ship the clevis hangers as separate pieces, in an unassembled form.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A clevis hanger for supporting a pipe, the hanger comprising:
a top portion having a pair of top apertures therein;
a bottom portion having a pair of bottom apertures therein;
a non-threaded fastener that is within the top apertures and the bottom apertures, thereby releasably securing the top portion and the bottom portion together;
wherein the bottom portion has a curved pipe-receiving section for receiving a pipe thereupon, secured within the top portion and the bottom portion.

2. The clevis hanger of claim 1,
wherein at least one end of the fastener is able to pass through the top apertures and the bottom apertures, when the top apertures are aligned with the bottom apertures; and
wherein the at least one end of the fasteners is not able to pass through the apertures when the top apertures are sufficiently misaligned with the bottom apertures.

3. The clevis hanger of claim 1, wherein the top apertures and the bottom apertures are slots.

4. The clevis hanger of claim 1, wherein narrowed portions of the fastener are located within the apertures when the fastener is installed.

5. The clevis hanger of claim 4, wherein the downward on the bottom portion causes motion of the bottom portion relative to the top portion, thereby pressing the narrowed portions of the fastener between parts of the top portion and parts of the bottom portion, and misaligning the bottom apertures from the top apertures.

6. The clevis hanger of claim 1, wherein the non-threaded fastener has a protrusion configured such that the fastener is able to pass through the apertures only when the fastener in a predetermined orientation relative to the apertures.

7. The clevis hanger of claim 1, wherein at least one of the apertures has an extension corresponding in shape to the protrusion.

8. The clevis hanger of claim 1, wherein the fastener is a retainer pin.

9. The clevis hanger of claim 8, wherein the retainer pin has a bent end.

10. The clevis hanger of claim 9, wherein the bent end is configured so as not to pass through the apertures when the retainer pin is inserted into the apertures.

11. The clevis hanger of claim 9, wherein the bent end is configured to pass through the apertures when the retainer pin inserted into the apertures.

12. The clevis hanger of claim 8, wherein the retainer pin has bent ends at respective opposite ends.

13. The clevis hanger of claim 12, wherein the bent ends are directed in different respective directions in planes parallel to an axis of the retainer pin.

14. The clevis hanger of claim 12, wherein the retainer pin has two pairs of protrusions, inboard of respective of the bent ends.

15. The clevis hanger of claim 8, wherein the retainer pin has a protrusion.

16. The clevis hanger of claim 1, wherein the fastener is a retainer bar.

17. The clevis hanger of claim 16,
wherein the retainer bar has pairs of notches therein; and
wherein the notched define narrowed portions of the retainer bar that rest in the apertures when the retainer bar is installed.

18. The clevis hanger of claim 1,
wherein the top portion has a pair of downward-protruding top legs linked by a linking support;
wherein each of the top legs has a respective of the top apertures therein;
wherein the bottom portion includes a pair of upward-protruding bottom legs coupled to the center pipe-receiving section; and
wherein each of the bottom legs has a respective of the bottom apertures therein.

19. The clevis hanger of claim 18, wherein the top legs overlap the bottom legs when the top apertures are aligned with the bottom apertures, with the top legs outboard of the bottom legs.

20. The clevis hanger of claim 18, wherein the linking support has a hole therein for coupling the top member to a support rod.
